(19) United States
(12) Patent Application Publication
(10) Pub. No.: US 2007/0131050 A1
(43) Pub. Date: Jun. 14, 2007

(54) Food processing machine gearbox

(76) Inventor: Martin John Nicholson, Waterlooville (GB)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/547,213

(22) PCT Filed: Feb. 2, 2004
(86) PCT No.: PCT/EP04/00908

§ 371 Date: Jun. 19, 2006

(30) Foreign Application Priority Data
Feb. 28, 2003 (GB) 0304608.3

(51) Int. Cl. F16H 3/14

(52) U.S. Cl. 74/355

(57) ABSTRACT

There is provided a gearbox for a food processing machine (10) comprising a first rotatable shaft; a second rotatable shaft; mountable to said first rotatable shaft, a rotary pulley (20) for receiving torque drive; mountable to said first rotatable shaft, first gear (20B); and mountable to said second rotatable shaft (10A), a second gear (10), wherein said first and second gears (20B, 10) are in meshed relationship thereby enabling geared transfer of torque from said first rotatable shaft to said second rotatable shaft (10A), and said second rotatable shaft is provided with a mounting for direct receipt of a primary food processing tool.

The present invention relates to a food processing machine for domestic or commercial use. A machine may be configured to operate as a blender, liquidiser, centrifuge, reamer, grater, processor, chopper, shredder, slicer, mixer, beater, whisk, mincer, extruder, grinder, peeler, juicer or any combination of such.

Food processing machines are well-known commercial and domestic appliances and are found in many kitchens. Typically, such food processing machines comprise a housing containing an electric drive motor its associated electronic control, switching mechanism, safety locks and a gearbox. The gearbox provides a mechanical link between the electric motor and a number of drive outputs on which various accessories or tools can be fitted. Each accessory or tool is designed to operate as a blender, liquidiser, centrifuge, reamer, grater, processor, chopper, shredder, slicer, mixer, beater, whisk, mincer, extruder, grinder, peeler juicer, or any combination of such.

Each accessory requires a range of drive characteristics comprising a combination of at least rotational speed and torque. The gearbox must be capable of transmitting the drive motor's output and converting it to the drive requirements of the associated or tool.

Existing gearbox designs employ gears and pulleys in various combinations, but do not provide all the required drive outputs necessary for efficient food processing. Many gearboxes, due to their complexity, are expensive to manufacture and inefficient in their operation. Every stage in a gearbox (belt drive or gear pair) introduces inefficiencies in power transfer. The more complex the gearbox is, the greater will be the inefficiency of the power transfer from the electric drive motor to the accessory's power input shaft.

The inefficiencies produce heat and noise. Heat in a gearbox reduces gear and bearing life. Gearbox designs often require lubrication to help improve efficiency and reduce damaging heat build up. Although often necessary in a food processing machine gearbox, lubricant is not desirable and is best kept to a minimum as it adds expense and can leak into the food being prepared.

To compensate for the gearbox inefficiency it is often necessary to generate more input power by increasing the size or speed of the electric drive motor. Unfortunately this further increases noise and heat generation. Noise is generally unwelcome by the user, especially if the food preparation requires a long processing time.

Due to existing gearbox limitations it remains difficult in practice to design a simple and efficient food processing machine that provides drive outputs working at their optimum speed and torque for the specific food preparation technique being undertaken. Food processing machine manufacturers are therefore continually striving to enhance the performance and efficiency of their products, whilst accepting that such enhancements can only be introduced if they are cost effective.

The applicant has devised a food processing machine gearbox comprising a belt (preferably toothed) and gear pair, which offers all the required drive outlets for accessories or tools such as blenders, liquidisers, centrifuges, reamers, graters, processors, choppers, shredders, slicers, mixers, beaters, whisks, mincers, extruders, grinders, peelers, juicers or any combination of such.

The gearbox operates in a quiet and efficient manner with minimal need of lubrication. In addition it is simple and cost effective to manufacture.

According to one aspect of the present invention there is provided a gearbox for a food processing machine comprising (e.g. consisting of)
a first rotatable shaft;
a second rotatable shaft;
mountable to said first rotatable shaft, a rotary pulley for receiving torque drive;
mountable to said first rotatable shaft, a first gear; and
mountable to said second rotatable shaft, a second gear,
wherein said first and second gears are in meshed relationship thereby enabling geared transfer of torque from said first rotatable shaft to said second rotatable shaft, and said second rotatable shaft is provided with a mounting for direct receipt of a primary food processing tool.

The rotary pulley is preferably toothed and shaped for receiving torque drive from a belt, preferably toothed. Suitably, the rotary pulley is sized to comprise from 50 to 240 teeth.

The first and second gears herein typically have a width of from 3 to 25 mm. The first gear typically comprises from 6 to 20 teeth and the second gear typically comprises from 40 to 240 teeth.

Suitably, the first and second rotatable shafts are non-concentric. That is to say, the two shafts do not share the same axis of rotation.

Suitably, the gearbox further comprises (e.g. consists of) a third rotatable shaft defining an axis of rotation parallel to that of said first rotatable shaft;
mountable to said third rotatable shaft, a rotary pulley for providing torque drive; arid
a belt for transferring torque drive from said rotary pulley of the third rotatable shaft to said rotary pulley of the first rotatable shaft.

The rotary pulley of the third rotatable shaft suitably comprises from 8 to 30 teeth.

Suitably, one or more of said first, second or third rotatable shafts are provided with a mounting for direct or indirect receipt of one or more secondary food processing tools.

Suitably, the gearbox further comprises a motor (e.g. an electric motor) for rotatably driving said third rotatable shaft. Exemplary types of motor include an induction motor, series motor or permanent magnet motor. Suitably, any electric motor includes an electronic control system.

Suitably, the gearbox further comprises a housing.

Suitably, the primary food processing tool is selected from the group consisting of blenders, liquidisers, juicers, centrifuges, reamers, graters, processors, choppers, shredders, slicers, mixers, beaters, whisks, mincers, extruders, grinders, peelers and any combination thereof.

Suitably, the one or more secondary food processing tools are selected from the group consisting of blenders, liquidisers, juicers, centrifuges, reamers, graters, processors, choppers, shredders, slicers, mixers, beaters, whisks, mincers, extruders, grinders, peelers and any combination thereof.

Suitably, the first rotatable shaft is drivable at a speed of from 0 to 5000 rpm.

Suitably, the second rotatable shaft is drivable at a speed of from 0 to 500 rpm.

Suitably, the third rotatable shaft is drivable at a speed of from 0 to 25000 rpm.

Suitably, the gearbox and any component parts thereof are made from metal, plastic, rubber or composite materials or any combination of these materials. Particular examples of materials of construction of the gearbox, including the gears and rotary pulley, include aluminium casting; zinc casting; metal pressing; machined metal or plastic parts; plastic mouldings; plastic moulding containing fibre or mineral filler; polypropylene mouldings; ABS mouldings; nylon mouldings; acetal mouldings; polycarbonate mouldings or polyester mouldings.

Suitable bearings for use in the gearbox herein include deep groove ball bearings; sintered phosphour bronze; moulded or machined acetal; or moulded or machined nylon.

According to another aspect of the present invention, there is also provided a food processing machine comprising a gearbox as described above.

Suitably, the food processing machine comprises the gearbox as described above and a driver motor drivably communicating with the rotary pulley of the gearbox to provide torque drive thereto.

Suitably, the drive motor communicates with the rotary pulley by way of a belt, preferably toothed. Other suitable communication means include a chain or a V-belt. The belt suitably has a width of from 6 to 20 mm.

Suitably, the invention provides an electric food processing machine for use in the preparation of food products.

Suitably, said machine comprises a body, for example, comprising a housing for the gearbox herein.

Suitably, within said body there is an electric motor that directly drives a high speed drive output and a reduced speed drive output (medium speed) via a (preferably toothed) belt drive. This medium speed drive shaft may also drive a third drive output via a single pair of gears. The pulleys and gears are arranged so as to give the optimum speeds and torques required at each output in a simple and energy efficient manner.

The object of food preparation is generally to modify one or more ingredients. These many and varied different food preparation techniques require various different processing techniques. These different processing techniques require mechanical drives with different speeds and powers.

For example, blending usually requires a high-speed low torque drive, while dough mixing requires a slow speed high torque drive.

The food processing machine comprises a body (or housing) and provided to the body, at least one output for driving attachments to process food, for example blending.

The body may have any suitable form including forms that are designed to be accommodated on a work surface in a domestic or commercial kitchen area.

The at least one drive output may be uncovered or may be closed off with a lid or cover. The said lid or cover may be interlocked to prevent accidental or unintentional access to the drive output.

The high speed drive output, typically running at between zero and 25000 rpm which is normally used to drive blenders, liquidisers, juice centrifuges and choppers.

The medium speed drive output typically running at between zero and 5000 rpm which is normally used to drive processors, choppers, shredders, slicers and graters.

The slow speed drive output typically running at between zero and 500 rpm which is normally used to drive mixers, beaters, whiskers and peelers often through a planetary drive.

A horizontal drive running at between zero and 500 rpm which is normally used to power mincers, extruders, grinders and reamers through a pair of bevel gears. The invention provides a food processing machine for use in food preparation. As a food processing machine it may be configured for domestic or commercial use and may have a suitable form including that of a single purpose blender, juicer, mixer, mincer, shredder, slicer, chopper etc.

In one preferred aspect, the food processing machine is configured as a multi function product. The at least one drive output takes the form of a rotating shaft that is sized and shaped to drive the required food processing attachment. Embodiments with multiple drive outputs are envisaged including 1 drive output, 2 drive output, 3 drive output. 4 drive output, 5 drive output and 6 drive outputs variations.

The at least one drive output is usually metal or plastic and formed in such a way as to connect with the corresponding feature on the food processing attachment and transmit the rotational energy. Power is usually provided through connecting the electric motor into the mains electricity supply.

Each drive output may be associated with its own food processing attachments but in variations one or more food processing attachments may be associated with a single drive output.

The food processing machine is provided with an electrical power control system for controlling the speed and power provided to the electrical drive motor. The motor control system generally comprises analogue and digital logic IC devices located on printed circuit boards with associated switches and safety interlocks.

In one preferred aspect, the electrical power control system incorporates at least 2 different motor speeds. That is to say, the drive motor is controllable to at least two different output speeds.

In another preferred aspect, the electric power control system incorporates many different motor speeds. That is to say, the drive motor is controllable to many different output speeds.

The exact values of the different motor speeds may be selected to match the requirements of the particular drive outputs being used, and in particular to achieve the correct and desired amount of food processing.

Embodiments of the present design will now be described with reference to the accompanying drawings in which.

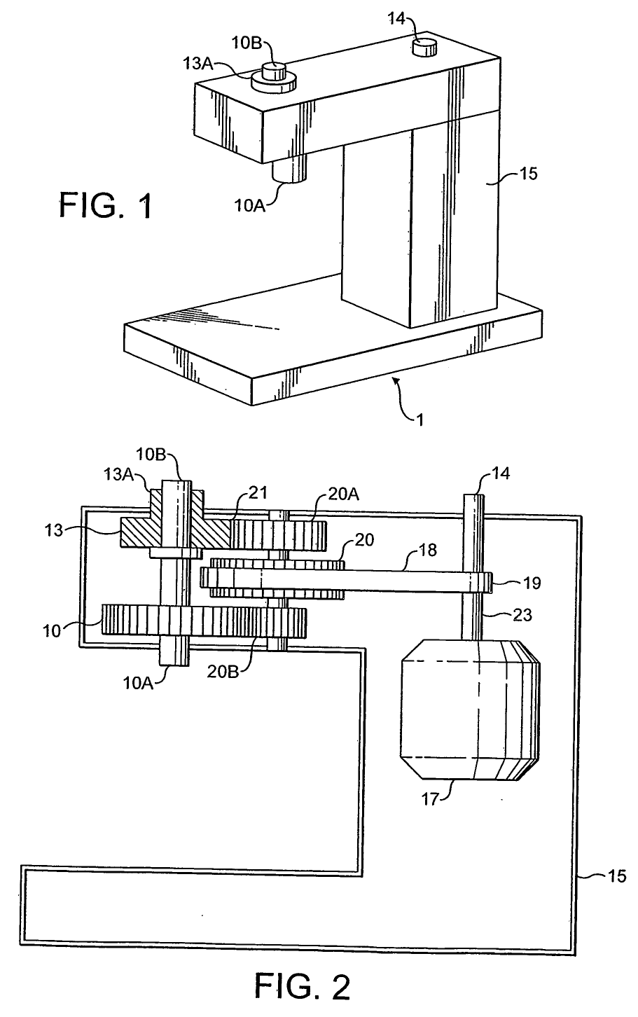

FIG. 1 is a perspective view of a basic 4-drive output food processing machine herein;

FIG. 2 is a side view, with side covers removed, of a basic 4-drive output food processing machine herein;

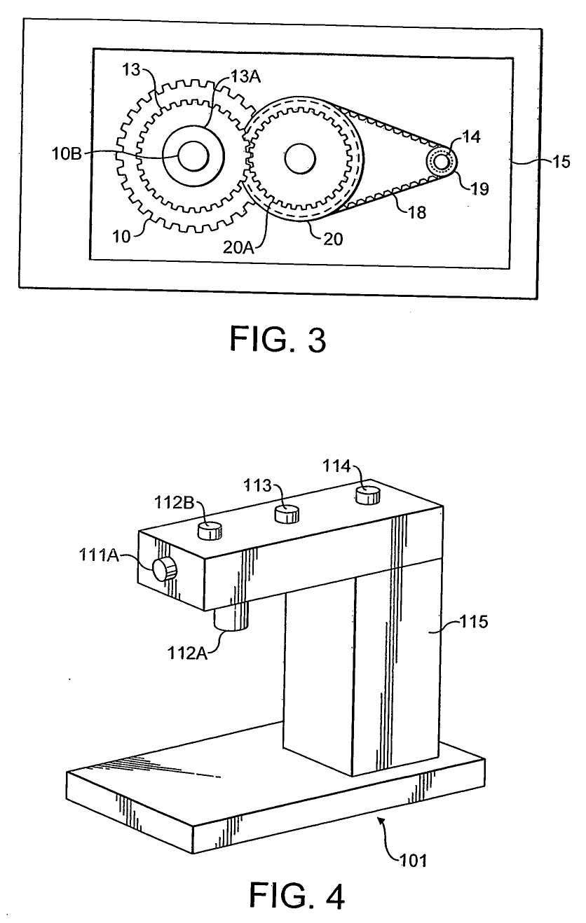

FIG. 3 is a plan view, with top cover removed, of a basic 4-drive output food processing machine herein;

FIG. 4 is a perspective view of a basic 5-drive output food processing machine herein;

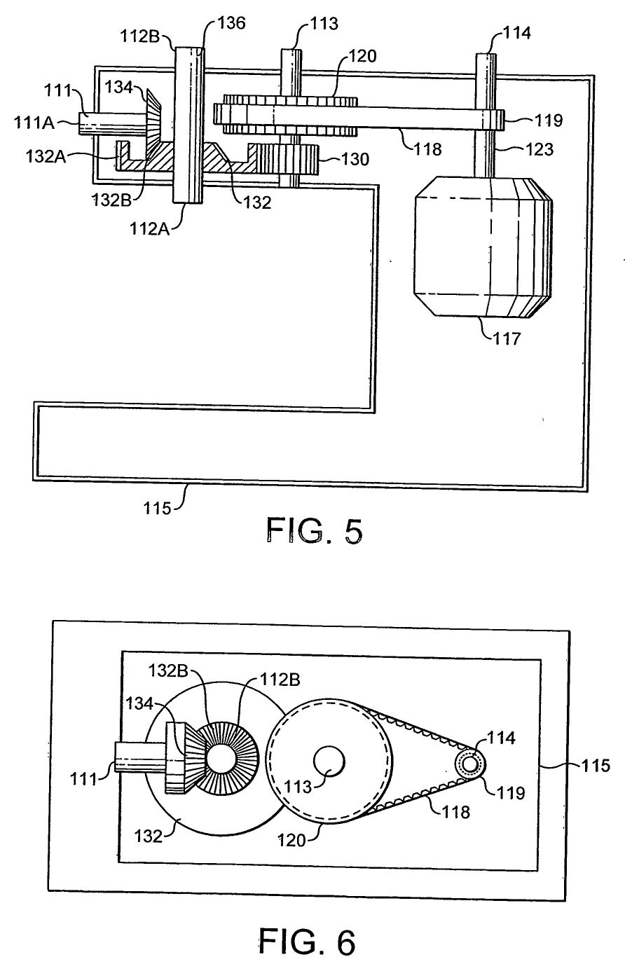

FIG. 5 is a side view, with side cover removed, of a basic 5-drive output food processing machine with an additional slow speed horizontal drive herein;

FIG. 6 is plan view of a basic 5 drive output food processing machine with an additional slow speed horizontal drive herein;

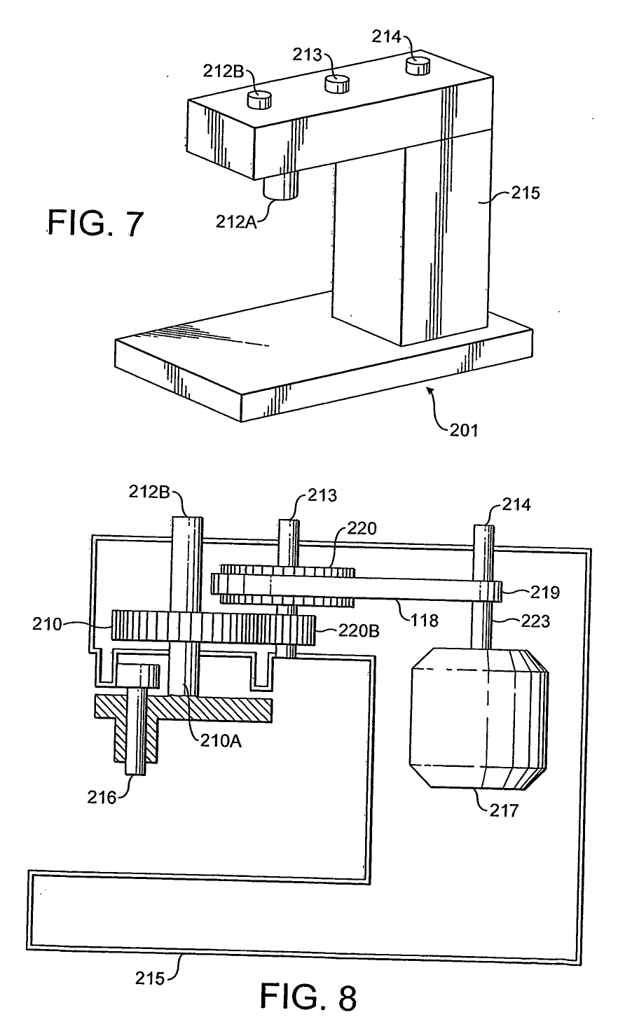

FIG. 7 is a perspective view of another basic 4-drive output food processing machine herein;

FIG. 8 is a side view, with side covers removed, of a basic 4-drive output food processing machine herein;

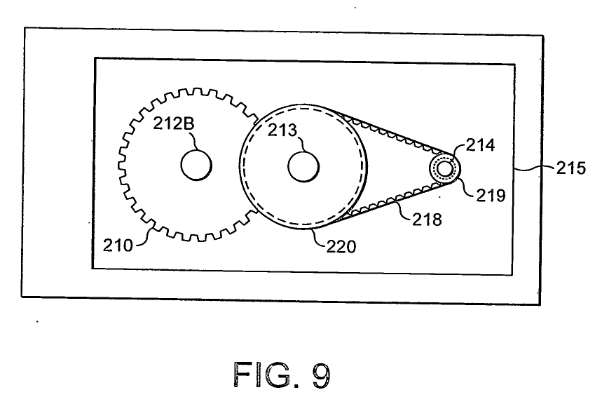

FIG. 9 is a plan view, with top cover removed, of a basic 4-drive output food processing machine herein;

FIG. 1 illustrates in perspective view, a 4 output drive food processing machine herein. The food processor 1 comprises a body 15, which is shaped to sit on a work surface (not shown). On the upper surface of the body there are three drive outputs 10B, 13A, 14 each with an associated locator specifically shaped to its drive. Each locator will accept food processing accessories or tools (not shown) that can only be docked with and locked on to it. On the under face of the top of the body 15 there is a fourth drive output 10A, often working through a planetary drive, which has its own associated locator specifically shaped to it's drive. It will also accept food processing accessories or tools (not shown) that can only be docked with and locked on to it.

FIG. 2 shows the body 15 within which is housed an electric motor 17 and its associated electronic controls, switches and safety interlocks (not shown). The motor 17 carries an extended shaft 23 on which is fixed a small diameter primary drive pulley 19 and a high-speed accessory drive 14. The pulley 19 drives a large diameter secondary pulley 20 by means of the belt 18 (preferably toothed). The secondary pulley 20 is integral with a shaft on which two gears are fixed, one gear 20A is located above pulley 20 the other gear 20B below it. Both gears 20A and 20B rotate at the same speed as pulley 20. The upper gear 20A forms a single pair of similar ratio gears 21.

The driven gear 13 is integral with the medium speed drive output 13A. Gear 20B drives gear 10 so that the rotational speed of gear 10 is less than that of gear 20B. Gear 10 is integral with and rotates at the same speed as the lower vertical slow speed drive 10A and the upper vertical slow speed drive 10B

FIG. 3 shows in plan view the body 15 where in is located the small diameter primary drive pulley 19 and a high-speed accessory drive 14. The pulley 19 drives a large diameter secondary pulley 20 by means of the (preferably toothed) belt 18. The secondary pulley 20 is integral with a shaft on which gear 20A is located. Gear 20A rotates at the same speed as pulley 20 and forms a single pair of similar ratio gears with driven gear 13. The driven gear 13 is integral with the medium speed drive output 13A. Gear 10 is driven by a smaller diameter gear 20B (not shown) and is integral with and rotates at the same speed as the upper vertical slow speed drive 10B.

FIG. 4 illustrates in perspective view, a basic 5-output drive food-processing machine herein. The food processor 101 comprises a body 115, which is shaped to sit on a work surface (not shown). On the upper surface of the body there are three drive outputs 1 12B, 113, 114 each with an associated locator specifically shaped to its drive. Each locator will accept accessories or tools (not shown) that can only be docked with and locked on to it. On the front face of the top of body 115 there is a fourth drive output 111A, which has its own associated locator specifically shaped to its drive, It will accept accessories or tools (not shown) that can only be docked with and locked on to it. On the under face of the top of the body 115 there is a fifth drive output 112A, often working through a planetary drive (not shown). 112A has its own associated locator specifically shaped to its drive. It will accept accessories or tools (not shown) that can only be docked with and locked on to it.

FIG. 5 shows a side view of the processing machine of FIG. 4 including body 115 within which is housed an electric motor 117 and its associated electronic controls, switches and safety interlocks (not shown). The motor 117 carries an extended shaft 123 on which is fixed a small diameter primary drive pulley 119 and a high-speed accessory drive 114. The pulley 119 drives a larger diameter secondary pulley 120 by means of the belt 118 (preferably toothed). The secondary pulley 120 is integral with a shaft, the top part of which forms the medium speed drive outlet 113. Pulley 120 is also integral with gear 130, which is located below pulley 120.

Gear 132 is a combined bevel and spur gear. For clarity the spur gear part of gear 132 will be referred to as spur gear 132A and the bevel gear part will be referred to as bevel gear 132B.

The combination gear 132 is driven by spur gear 130. Since gear 130 is smaller than spur gear 132A the rotational speed of gear 132 is less than that of gear 130. Shaft 136 is an integral part of the combination gear 132. The top end of shaft 136 is configured to provide the vertical slow speed drive output 112B. The other end of the shaft is configured to provide the lower vertical slow speed drive output 112A. Often working through a planetary drive (not shown).

The horizontal slow speed drive output shaft 111 is an integral part of bevel gear 134, which is driven by bevel gear 132B. At the external end of shaft 111 there is located the horizontal slow speed drive outlet 111A

FIG. 6 shows in plan view body 115 of the machine of FIGS. 4 and 5 wherein is located the small diameter primary drive pulley 119 and a high-speed accessory drive 114. The pulley 119 drives a large diameter secondary pulley 120 by means of the belt 118 (preferably toothed). The secondary pulley 120 is integral with a shaft on which is formed the medium speed drive outlet 113. Pulley 120 is also integral with gear 130 (not shown), which is located below pulley 120. Gear 130 (not shown) drives combination spur and bevel gear 132, which in turn drives bevel gear 134, which is an integral part of the horizontal slow speed drive output shaft 111. Part 112B is the vertical slow speed drive output and is an integral part with the combination gear 132.

FIG. 7 illustrates in perspective view, an alternative 4 output drive food processing machine herein. The food processor 201 comprises a body 215, which is shaped to sit on a work surface (not shown). On the upper surface of the body there are three drive outputs 212B, 213, 214 each with an associated locator specifically shaped to its drive. Each locator will accept accessories or tools (not shown) that can only be docked with and locked on to it. On the under face of the top of the body 215 there is a fourth drive output 212A, often working through a planetary drive (not shown), which has its own associated locator specifically shaped to it's drive. It will accept accessories or tools (not shown) that can only be docked with and locked on to it.

FIG. 8 shows the body 215 of the machine of FIG. 7 within which is housed an electric motor 217 and its associated electronic controls, switches and safety interlocks (not shown). The motor 217 carries an extended shaft 223 on which is fixed a small diameter primary drive pulley 219 and a high-speed accessory drive output 214. The pulley 219 drives a large diameter secondary pulley 220 by means of the belt 218 (preferably toothed). The secondary pulley 220 is integral with a shaft, the top part of which forms the medium speed drive output 213. Pulley 220 is also integral with gear 220B, which is located below pulley 220.

Gears 220B rotates at the same speed as pulley 220.

Gear 220B drives gear 210 so that the rotational speed of gear 210 is less than that of gear 220B. Gear 210 is integral with and rotates at the same speed as the vertical slow speed shaft 210A.

Shaft 210A is integral with a slow speed drive output 212B and often works through a planetary drive 216, which has its own associated locator specifically shaped to its drive. It will accept accessories or tools (not shown) that can only be docked with and locked on to it.

FIG. 9 shows in plan view the body 215 of the machine of FIGS. 7 and 8 where in is located the small diameter primary drive pulley 219 and a high-speed accessory drive 214. The pulley 219 drives a large diameter secondary pulley 220 by means of the belt (preferably toothed) 218. The secondary pulley 220 is integral with a shaft 213. Gear 210 is driven by a smaller diameter gear 220B (not shown) and is integral with and rotates at the same speed as the vertical slow speed drive output 212B.

The invention provides a food processing machine gearbox comprising a belt and gear pair, which offers all the required drive outlets for accessories or tools such as blenders, liquidisers, juicers, centrifuges, reamers, graters, processors, choppers, shredders, slicers, mixers, beaters, whisks, mincers, extruders, grinders, peelers or any combination of such.

The gearbox according uses a belt and gear combination, which result in a reduced number of energy transfer points, resulting in lower energy losses.

The gearbox provides for lower energy losses and is operable at reduced noise levels for each type of food processing.

The gearbox requires reduced amounts of lubrication.

The gearbox is for use within an electric food processing machine which is intended to be used in the preparation of food products.

In one aspect, the machine comprises a body and within said body an electric motor that directly drives a gearbox according to all previous claims.

The electric motor suitably comprises an electronic control system for controlling the motor.

Suitably, the electronic control system controls the motor speed typically between zero and 20000 rpm.

The electronic control system generally comprises analogue and digital logic IC devices located on printed circuit boards with associated switches and safety interlocks.

In aspects, the gearbox provides a vertical high-speed drive located on the top surface of the machine that is configured to power selected and accessories according to claim all previous claims.

Suitably, the high speed drive runs between the speed of zero and 25000 rpm.

Suitably, the gearbox uses a belt, (preferably toothed), driven pulley system to provide power to a vertical medium speed drive located on the top surface of the kitchen machine, this drive is configured to power selected kitchen tools and accessories.

Suitably, the medium speed vertical drive runs between the speed of zero and 5000 rpm.

Suitably, the gearbox uses a belt, (preferably toothed) driven pulley and gear system to provide power to a vertical slow speed drive that is located on the top surface of the machine configured to power selected kitchen tools and accessories.

Suitably, the slow speed vertical drive is located on the top surface of the machine and runs typically between the speed of zero and 500 rpm.

Suitably, the gearbox uses a (preferably toothed) belt, pulleys and a gear system to provide power to a vertical slow speed drive, located on the lower surface of the machine which is configured to power selected tools and accessories.

Suitably, the slow speed vertical drive is located on the lower surface of the machine, often working through a planetary drive, that runs typically between the speed of zero rpm and 500 rpm.

Suitably, the gearbox and any component parts thereof are made from metal, plastic, rubber or composite materials or any combination of these materials.

1. A gearbox for a food processing machine comprising
a first rotatable shaft;
a second rotatable shaft;
mountable to said first rotatable shaft, a rotary pulley for receiving torque drive;
mountable to said first rotatable shaft, a first gear; and
mountable to said second rotatable shaft, a second gear,
wherein said first and second gears are in meshed relationship thereby enabling geared transfer of torque from said first rotatable shaft to said second rotatable shaft, and said second rotatable shaft is provided with a mounting for direct receipt of a primary food processing tool.

2. A gearbox according to claim 1 further comprising a third rotatable shaft defining an axis of rotation parallel to that of said first rotatable shaft;
mountable to said third rotatable shaft, a rotary pulley for providing torque drive; and
a belt for transferring torque drive from said rotory pulley of the third rotatable shaft to said rotary pulley of the first rotatable shaft.

3. A gearbox according to claim 2, wherein one or more of said first, second or third rotatable shafts are provided with a mounting for direct or indirect receipt of one or more secondary food processing tools.

4. A gearbox according to claim 3, further comprising a motor for rotatably driving said third rotatable shaft.

5. A gearbox according to claim 4, further comprising a housing.

6. A gearbox according to claim 5, wherein said primary food processing tool is selected from the group consisting of blenders, liquidisers, juicers, centrifuges, reamers, graters, processors, choppers, shredders, slicers, mixers, beaters, whisks, mincers, extruders, grinders, peelers and any combination thereof.

7. A gearbox according to claim 3, wherein said one or more secondary food processing tools are selected from the group consisting of blenders, liquidisers, juicers, centrifuges, reamers, graters, processors, choppers, shredders, slicers, mixers, beaters, whisks, mincers, extruders, grinders, peelers and any combination thereof.

8. A gearbox according to claim 1, wherein said first rotatable shaft is drivable at a speed of from 0 to 5000 rpm.

9. A gearbox according to claim 1, wherein said second rotatable shaft is drivable at a speed of from 0 to 500 rpm.

10. A gearbox according to claim 2, wherein said third rotatable shaft is drivable at a speed of from 0 to 25000 rpm.

11. A gearbox according to claim 1, wherein the gearbox and any component parts thereof are made from metal, plastic, rubber or composite materials or any combination of these materials.

12. A food processing machine comprising a gearbox according to claim 1.

13. A food processing machine according to claim 12, additionally comprising a drive motor drivably communicating with the rotary pulley to provide torque drive thereto.

14. A food processing machine according to claim 13, wherein said drive motor communicates with the rotary pulley by way of a belt, preferably a toothed belt.

15. A food processing machine according to claim 13, wherein the drive motor is provided with an electrical power control system for controlling the drive speed thereof.

16. A gearbox according to claim 2, wherein said first rotatable shaft is drivable at a speed of from 0 to 5000 rpm.

17. A gearbox according claim 16, wherein said second rotatable shaft is drivable at a speed of from 0 to 500 rpm.

18. A gearbox according to claim 17, wherein said third rotatable shaft is drivable at a speed of from 0 to 25000 rpm.

19. A food processing machine comprising a gearbox according to claim 18.

20. A food processing machine according to claim 14, wherein the drive motor is provided with an electrical power control system for controlling the drive speed thereof.
